(19) United States
(12) Patent Application Publication
(10) Pub. No.: US 2026/0087573 A1
(43) Pub. Date: Mar. 26, 2026

(54) INFORMATION PROCESSING SYSTEM AND INFORMATION PROCESSING METHOD

(71) Applicant: Semiconductor Energy Laboratory Co., Ltd., Atsugi-shi (JP)

(72) Inventors: Junpei MOMO, Sagamihara (JP); Hiroki HOSOSHIMA, Atsugi (JP)

(21) Appl. No.: 19/324,368

(22) Filed: Sep. 10, 2025

(30) Foreign Application Priority Data
Sep. 20, 2024 (JP) 2024-163471

(51) Int. Cl. G06Q 50/18; G06F 40/30

(52) U.S. Cl. CPC G06Q 50/184; G06F 40/30

(57) ABSTRACT

An inventor's maintenance or abandonment sorting task of a patent is assisted and creation of a reason for maintenance or abandonment of the patent that could convince the inventor is assisted. An information processing system has a function of performing processing using a language model, a function of generating a summary of patent information from the patent information, a function of generating a question relating to the patent, a function of generating a maintenance or abandonment determination result of the patent from the summary of the patent information, the question, and a reply to the question, and a function of generating a reason for maintenance or abandonment of the patent from the summary of the patent information, the maintenance or abandonment determination result of the patent, similar patents that have been determined to be maintained or abandoned, and reasons for determining maintenance or abandonment of the similar patents.

### BACKGROUND OF THE INVENTION

### 1. Field of the Invention

The present invention relates to a language model, in particular, an information processing system and an information processing method utilizing a generative AI model.

Note that one embodiment of the present invention is not limited to the above technical field. Examples of the technical field of one embodiment of the present invention disclosed in this specification and the like include a semiconductor device, a display device, a light-emitting device, a power storage device, a memory device, an electronic device, a lighting device, an input device, an input/output device, a driving method thereof, and a manufacturing method thereof. A semiconductor device generally means a device that can function by utilizing semiconductor characteristics.

### 2. Description of the Related Art

In recent years, language models using neural networks have been actively developed, and especially large language models (LLM) have attracted attention. An LLM is a natural language processing model learned using a large amount of data. With an LLM, for example, a conversational model that gives an answer to a user's instruction can be achieved. In Non-Patent Document 1, generative pre-trained transformer 4 (GPT-4, registered trademark) is disclosed as an LLM, and ChatGPT is disclosed as a conversational model.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

A patent application of an invention is granted a patent after examination. To maintain the patent right thereafter, maintenance fees need to be paid. However, the patent might be no longer needed during the maintenance period as the technical trend might change. It is thus necessary to determine whether the patent needs to be obtained and maintained even after the patent application in consideration of the value of the invention. Meanwhile, inventors and patent engineers expend enormous efforts to determine whether the patent needs to be obtained and maintained. In addition, evaluation of the value of the invention and determination of maintenance or abandonment of the patent are exceedingly difficult and cannot be made mechanically. Even though an inventor understands the value of the invention and has information for determining maintenance or abandonment of the patent, it is difficult for the inventor to make decision.

In view of the above problems, an object of the present invention is to assist an inventor in carrying out a maintenance or abandonment sorting task of a patent and creating a reason for maintenance or abandonment of the patent that could convince the inventor. Here, a maintenance or abandonment sorting task of a patent is to determine whether the right of the patent applied needs to be maintained in consideration of the value of the invention.

Note that the description of these objects does not preclude the existence of other objects. One embodiment of the present invention does not need to achieve all these objects. Other objects will be apparent from and can be derived from the description of the specification, the drawings, the claims, and the like.

In view of the above problems, one embodiment of the present invention is an information processing system including a first information processing device and a second information processing device. The first information processing device has a function of receiving a first instruction sentence, a second instruction sentence, a third instruction sentence, and a fourth instruction sentence, performing processing using a language model, and outputting a first answer sentence, a second answer sentence, a third answer sentence, and a fourth answer sentence. The second information processing device has a function of receiving patent information of a patent to be maintained or abandoned; a function of creating the first instruction sentence from the patent information; a function of transmitting the first instruction sentence to the first information processing device and receiving the first answer sentence including a summary of the patent information; a function of creating the second instruction sentence from the summary of the patent information; a function of transmitting the second instruction sentence to the first information processing device and receiving the second answer sentence including a question relating to the patent; a function of outputting the question relating to the patent; a function of receiving a first reply including an answer to the question relating to the patent; a function of creating the third instruction sentence from the question relating to the patent, the first reply, and the summary of the patent information; a function of transmitting the third instruction sentence to the first information processing device and receiving the third answer sentence including a maintenance or abandonment determination result of the patent; a function of obtaining similar patents that have been determined to be maintained or abandoned and reasons for determining maintenance or abandonment of the similar patents; a function of creating the fourth instruction sentence from the summary of the patent information, the maintenance or abandonment determination result of the patent, the similar patents that have been determined to be maintained or abandoned, and the reasons for determining maintenance or abandonment of the similar patents; a function of transmitting the fourth instruction sentence to the first information processing device and receiving the fourth answer sentence including a reason for maintenance or abandonment of the patent; a function of outputting the reason for maintenance or abandonment of the patent; and a function of storing the reason for maintenance or abandonment of the patent.

In the above information processing system, the first information processing device preferably has a function of receiving a fifth instruction sentence, performing processing using the language model, and outputting a fifth answer sentence, and the second information processing device preferably has a function of receiving a second reply including whether or not a correction of the reason for maintenance or abandonment of the patent is necessary; a function of creating the fifth instruction sentence from the fourth instruction sentence, the fourth answer sentence, and the second reply; and a function of transmitting the fifth instruction sentence to the first information processing device and receiving the fifth answer sentence including a corrected reason for maintenance or abandonment of the patent.

One embodiment of the present invention is an information processing method including a first step to a fifteenth step: the first step of obtaining patent information of a patent to be maintained or abandoned; the second step of creating a first instruction sentence from the patent information; the third step of inputting the first instruction sentence to a language model to obtain a first answer sentence including a summary of the patent information; the fourth step of creating a second instruction sentence from the summary of the patent information; the fifth step of inputting the second instruction sentence to the language model to obtain a second answer sentence including a question relating to the patent; the sixth step of outputting the question relating to the patent; the seventh step of obtaining a first reply including an answer to the question relating to the patent; the eighth step of creating a third instruction sentence from the question relating to the patent, the first reply, and the summary of the patent information; the ninth step of inputting the third instruction sentence to the language model to obtain a third answer sentence including a maintenance or abandonment determination result of the patent; the tenth step of returning to the fourth step when maintenance or abandonment of the patent cannot be determined and proceeding to the eleventh step when the maintenance or abandonment of the patent can be determined; the eleventh step of obtaining similar patents that have been determined to be maintained or abandoned and reasons for determining maintenance or abandonment of the similar patents; the twelfth step of creating a fourth instruction sentence from the similar patents that have been determined to be maintained or abandoned, the reasons for determining maintenance or abandonment of the similar patents, and the summary of the patent information; the thirteenth step of inputting the fourth instruction sentence to the language model to obtain a fourth answer sentence including a reason for maintenance or abandonment of the patent; the fourteenth step of outputting the reason for maintenance or abandonment of the patent; and the fifteenth step of storing the reason for maintenance or abandonment of the patent.

In the above information processing method, a sixteenth step to a nineteenth step are preferably included after the fourteenth step: the sixteenth step of obtaining a second reply including whether or not a correction of the reason for maintenance or abandonment of the patent is necessary; the seventeenth step of proceeding to the fifteenth step when the correction of the reason for maintenance or abandonment of the patent is not necessary and proceeding to the eighteenth step when the correction is necessary; the eighteenth step of creating a fifth instruction sentence from the fourth instruction sentence, the fourth answer sentence, and the second reply; and the nineteenth step of inputting the fifth instruction sentence to the language model, obtaining a corrected reason for maintenance or abandonment of the patent, and proceeding to the fourteenth step.

According to one embodiment of the present invention, it is possible to assist an inventor in carrying out a maintenance or abandonment sorting task of a patent in accordance with the inventor's intention and creating a reason for maintenance or abandonment of the patent that could convince the inventor, so that the reason for maintenance or abandonment of the patent can be created without help of patent engineers.

### BRIEF DESCRIPTION OF THE DRAWINGS

In the accompanying drawings:

FIG. 1 is a schematic diagram showing a configuration example of an information processing system;

FIG. 2 is a block diagram showing a configuration example of an information processing system;

FIG. 3 is a flowchart showing a processing example of an information processing system;

FIG. 4 is a flowchart showing a processing example of an information processing system;

FIG. 5 is a flowchart showing a processing example of an information processing system; and

FIG. 6 is a flowchart showing a processing example of an information processing system.

### DETAILED DESCRIPTION OF THE INVENTION

Embodiment will be described below with reference to the drawings. Note that the embodiment can be implemented with many different modes, and it will be readily understood by those skilled in the art that modes and details thereof can be changed in various ways without departing from the spirit and scope thereof. Therefore, the present invention should not be construed as being limited to the description of the embodiment below.

Note that in structures of the invention described below, the same portions or portions having similar functions are denoted by the same reference numerals in different drawings, and the description thereof is not repeated. Furthermore, portions having similar functions are not denoted by specific reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that in this specification and the like, ordinal numbers such as “first” and “second” are used in order to avoid confusion among components and do not limit the number of components. The ordinal numbers do not denote the priority or the order such as the order of steps or the stacking order. A term without an ordinal number in this specification and the like might be provided with an ordinal number in a claim in order to avoid confusion among components. A term with an ordinal number in this specification and the like may be described with a different ordinal number in a claim. A term with an ordinal number in this specification and the like may be described without an ordinal number in a claim.

Note that in this specification and the like, a language model is an interactive (also referred to as conversational) model based on a transformer architecture and obtained by additional learning. A typical language model is a large language model (LLM). The LLM performs processing based on supplied text data and is specialized for a text generation function, and generative AI has not only the text generation function but also an image generation function based on image data. That is, the large language model is one kind of generative AI.

### Embodiment 1

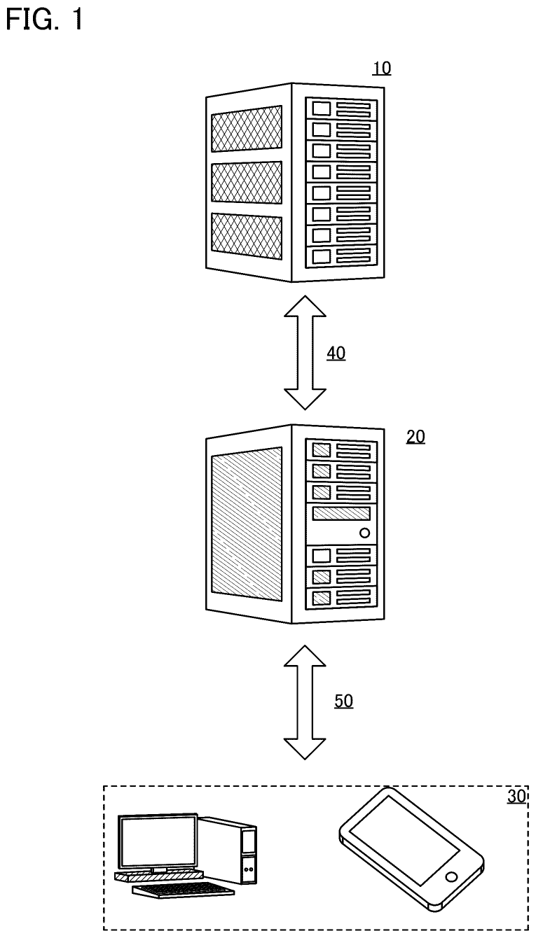

In this embodiment, a configuration example of an information processing system of one embodiment of the present invention is described with reference to FIG. 1.

The information processing system of one embodiment of the present invention outputs a question relating to a patent from patent information of a patent to be maintained or abandoned by utilizing a language model. Furthermore, from the patent information, the question relating to the patent, and a reply to the question relating to the patent, whether the patent is maintained or abandoned is determined by utilizing a language model. It is also possible to output a reason for maintenance or abandonment of the patent by utilizing a language model and similar patents that have been determined to be maintained or abandoned.

More specific examples are described below with reference to drawings.

### <Configuration Example of Information Processing System>

As illustrated in FIG. 1, the information processing system of this embodiment preferably includes a first information processing device 10, a second information processing device 20, and an information terminal 30. The second information processing device 20 is connected to the first information processing device 10 through a network 40. The second information processing device 20 is connected to the information terminal 30 through a network 50.

In the information processing device of this embodiment, the device structure in FIG. 1 is one example; the second information processing device 20 may have a function of the first information processing device 10, and a function of the second information processing device 20 can be dispersedly implemented in a plurality of information processing devices.

### <<Configuration Example of Information Terminal 30>>

In a configuration example of the information processing system, the information terminal 30 is operated by a user and can be referred to as a client computer or the like. Although a desktop computer and a smartphone are illustrated as examples in FIG. 1, a laptop computer or a tablet computer may be used as the information terminal 30. A tablet computer may be used by being connected to a housing including an input portion (typically, a keyboard). In the present invention, the user preferably understands the details of a patent to be maintained or abandoned; examples of the user include an inventor.

### <<Configuration Example of First Information Processing Device 10>>

Next, a configuration example of the first information processing device 10 is described.

The first information processing device 10 can perform processing using a language model. In particular, the first information processing device 10 can perform processing using a model utilizing a large language model (a text generation model, an interactive model, or the like). For example, processing can be executed using large language models such as GPT-4 (registered trademark), Llama2, and Llama3. Note that in this specification and the like, the language model includes the large language model.

The first information processing device 10 has a function of receiving an instruction sentence. The first information processing device 10 has a function of outputting an answer sentence to the instruction sentence with the use of the language model, and can execute a variety of natural language processing tasks such as translating and summarizing.

A service provider using the information processing system of one embodiment of the present invention does not necessarily have his or her own first information processing device 10. For example, the service provider can use part of the service that is provided by another company or the like as the first information processing device 10.

### <<Configuration Example of Second Information Processing Device 20>>

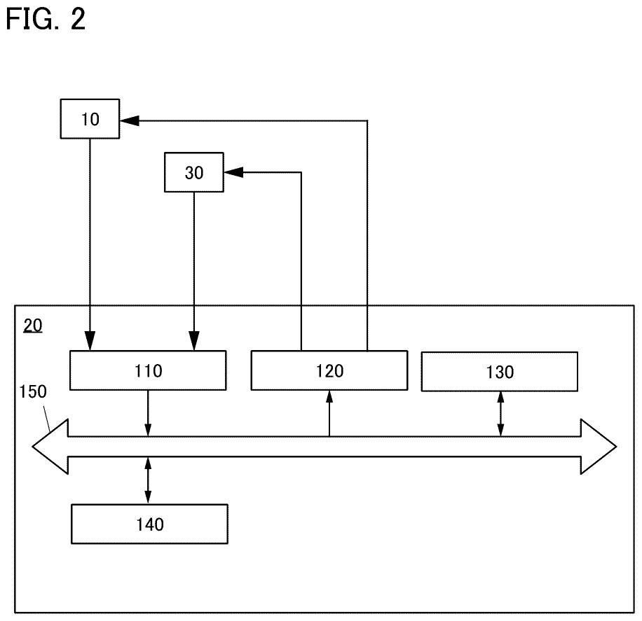

Next, a configuration example of the second information processing device 20 is described with reference to FIG. 2.

As illustrated in FIG. 2, the second information processing device 20 includes a reception portion 110, an output portion 120, a memory portion 130, a processing portion 140, and a transmission path 150. FIG. 2 illustrates the first information processing device 10 and the information terminal 30 in addition to the second information processing device 20, and arrows indicate data transmission and reception. The reception portion and the output portion are collectively referred to as a communication portion in some cases. With the communication portion, the second information processing device 20 can transmit and receive data to and from the outside.

### [Reception Portion 110]

The reception portion 110 has a function of receiving data from the outside. As the reception portion 110, a communication port or an input device such as a personal computer having a communication function may be used, for example.

Examples of the data that the reception portion 110 receives from the first information processing device 10 include a summary of patent information output by the language model in the first information processing device 10. The reception portion 110 can receive the patent information, a first reply, a second reply, and the like from the information terminal 30.

The reception portion 110 can supply the received data to one or more selected from the memory portion 130 and the processing portion 140 through the transmission path 150.

### [Output Portion 120]

The output portion 120 has a function of outputting data or the like processed in the processing portion 140 to the outside. For example, the output portion 120 can transmit an instruction sentence to the first information processing device 10. The output portion 120 can also output a question relating to the patent, a reason for maintenance or abandonment of the patent, or the like to the information terminal 30. As the output portion 120, a communication port or a device such as a personal computer having a communication function may be used, for example.

### [Memory Portion 130]

The memory portion 130 has a storage function. The memory portion 130 is a memory region, which can store a program and/or data, for example. A typical example of the program is a program executed by the processing portion 140. The data includes data received by the reception portion 110 (e.g., patent information). The data also includes data generated by the language model (e.g., a summary of the patent information and a question relating to the patent) and information of patents that have been determined to be maintained or abandoned which is processed by the information processing system.

The memory portion 130 may include a database. The second information processing device 20 may include another database in addition to the memory portion 130. The second information processing device 20 may have a function of extracting data from a database outside of the memory portion 130, outside of the second information processing device 20, or outside of the information processing system. The second information processing device 20 may have a function of extracting data from both of its own database and an external database.

One or both of a storage and a file server can be used as the memory portion 130. In addition, a database in which a path of a file stored in the file server is recorded can be used as the memory portion 130.

The memory portion 130 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The memory portion 130 may include at least one of a NOSRAM (registered trademark) and a DOSRAM (registered trademark). The memory portion 130 may include a recording media drive. Examples of the recording media drive include a hard disk drive (HDD) and a solid state drive (SSD).

The NOSRAM is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM can be used as a nonvolatile memory by retaining electric charge corresponding to data in memory cells, using characteristics of extremely low leakage current. In particular, the NOSRAM is capable of reading retained data without destruction (non-destructive reading), and thus is suitable for arithmetic processing in which only data reading operations are repeated many times. The NOSRAM can have large data capacity when stacked in layers, and thus can increase the performance of a semiconductor device when used as a large-scale cache memory, main memory, or storage memory.

The DOSRAM is an abbreviation for “dynamic oxide semiconductor RAM” and refers to a RAM including a one-transistor (1T) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably includes indium (In). When the metal oxide included in the channel formation region is a metal oxide including indium, the carrier mobility (electron mobility) of the OS transistor is high. For example, indium oxide can be suitably used as the metal oxide included in the channel formation region. The metal oxide included in the channel formation region is preferably an oxide semiconductor including an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide included in the channel formation region is preferably a metal oxide including zinc (Zn). The metal oxide including zinc is easily crystallized in some cases. For example, indium gallium zinc oxide (also referred to as IGZO) or indium tin oxide (also referred to as ITZO (registered trademark)) can be used as the metal oxide included in the channel formation region.

The metal oxide included in the channel formation region is not limited to the metal oxide including indium. The metal oxide included in the channel formation region may be, for example, a metal oxide that does not include indium but includes any of zinc, gallium, and tin (e.g., zinc tin oxide and gallium tin oxide).

### [Processing Portion 140]

The processing portion 140 has a function of performing processing such as arithmetic operation and analysis with use of data supplied from one or both of the reception portion 110 and the memory portion 130. The processing portion 140 can supply processed data to one or both of the memory portion 130 and the output portion 120.

The processing portion 140 can include an arithmetic circuit, for example. The processing portion 140 can include a central processing unit (CPU), for example. The processing portion 140 can include a graphics processing unit (GPU) in addition to or instead of the CPU. Furthermore, the processing portion 140 can include a neural processing unit/neural network processing unit (NPU).

The processing portion 140 may include a register and a main memory in addition to the CPU. The register and the main memory are sometimes included in the CPU. The main memory can transmit and receive data to and from a secondary cache or the like. The main memory includes at least one of a volatile memory such as a random access memory (RAM) and a nonvolatile memory such as a read only memory (ROM). The main memory may include at least one of a NOSRAM and a DOSRAM. The main memory can include one or both of an OS transistor and a transistor including silicon in a channel formation region (also referred to as a Si transistor). Note that the configurations of the register and the main memory can be understood by replacing the CPU in this paragraph with the GPU.

Examples of the RAM include a DRAM and an SRAM. When a virtual memory space is assigned to the DRAM or the SRAM, the processing portion 140 can use the memory space as a work space. An operating system, an application program, a program module, program data, a look-up table, and the like which are stored in the memory portion 130 are loaded into the RAM immediately before execution. The processing portion 140 can access and operate the operating system, the application program, the program module, the program data, the look-up table, and the like via the RAM.

A system that does not require rewriting can be stored in the ROM, for example. As the system that does not require rewriting, firmware such as a basic input/output system (BIOS) can be given. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing portion 140 may include a microprocessor such as a digital signal processor (DSP) in addition to the CPU or the GPU. The DSP is specialized in digital signal processing and is thus preferably included to control a peripheral circuit and the like of the CPU or the GPU. The microprocessor may be configured with a programmable logic device (PLD), which is operated by hardware, such as a field programmable gate array (FPGA) or a field programmable analog array (FPAA).

The second information processing device 20 has a function of creating an instruction sentence from text data in the processing portion 140. Specifically, the second information processing device 20 has a function of creating a first instruction sentence from patent information, creating a second instruction sentence from a summary of the patent information, creating a third instruction sentence from a reply to a question relating to the patent and the summary of the patent information, creating a fourth instruction sentence from the summary of the patent information, a maintenance or abandonment determination result of the patent, similar patents that have been determined to be maintained or abandoned, reasons for determining maintenance or abandonment of the similar patents, and the like.

The second information processing device 20 also has a function of searching for similar patents that have been determined to be maintained or abandoned in the processing portion 140.

The second information processing device 20 may also have a function of, in the processing portion 140, inputting the fourth instruction sentence to a language model included in the first information processing device and creating a fifth instruction sentence from an output fourth answer sentence and a user's reply to the reason for maintenance or abandonment of the patent.

### [Transmission Path 150]

The transmission path 150 has a function of transmitting data. Data transmission and reception among the reception portion 110, the output portion 120, the memory portion 130, and the processing portion 140 can be performed through the transmission path 150. As the transmission path 150, for example, an external bus, a local area network (LAN), and the Internet, which is the infrastructure of the World Wide Web (WWW), may be used.

### <Processing Example of Information Processing System>

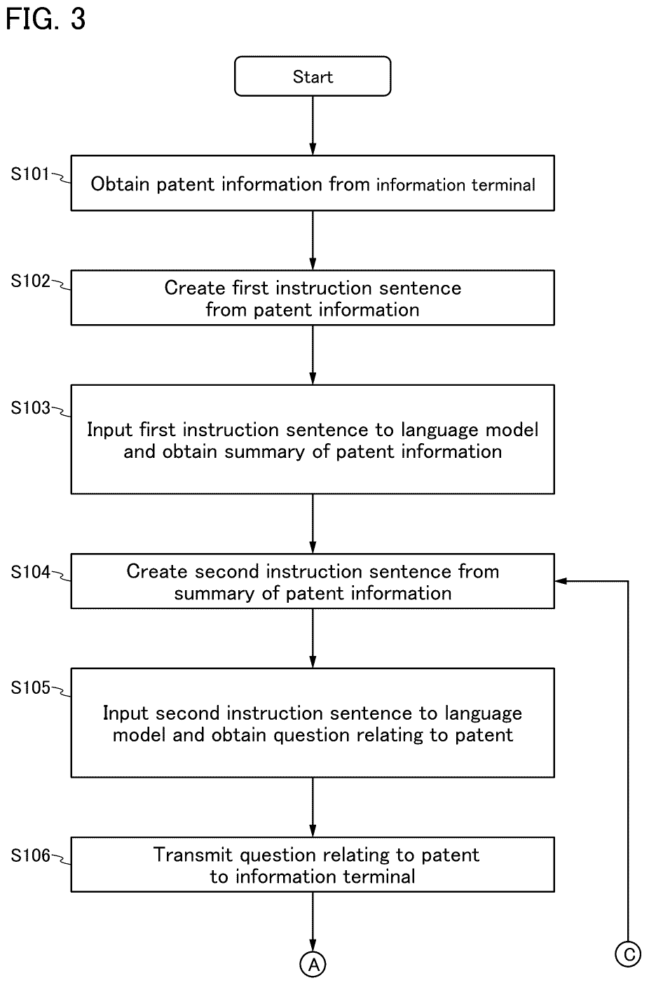

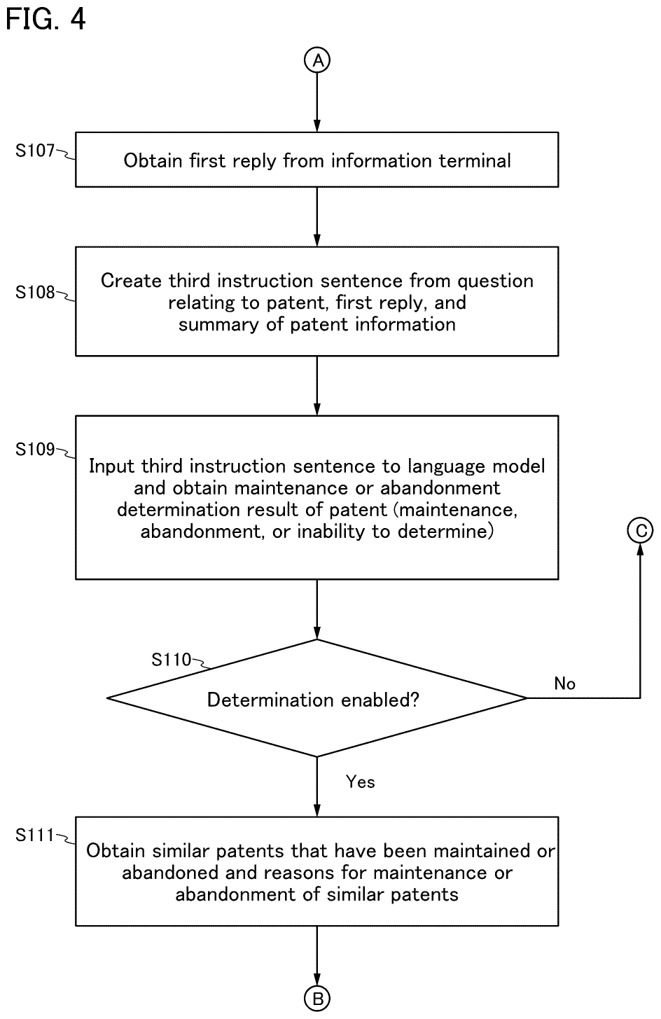

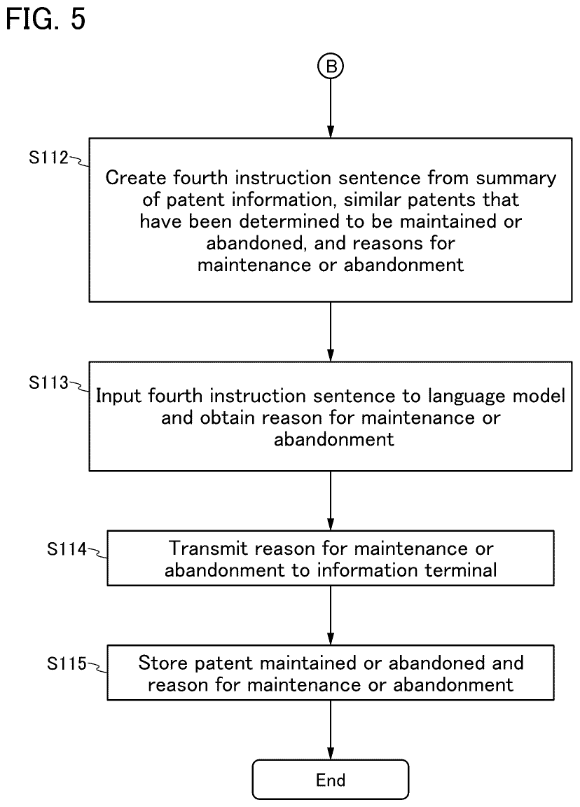

FIG. 3, FIG. 4, and FIG. 5 are flowcharts each showing an example of steps relating to the information processing system of one embodiment of the present invention.

### <Step S101>

In Step S101, the second information processing device 20 obtains patent information from a user.

The patent information includes text data of a patent to be maintained or abandoned, such as a specification, claims, an application date, a prosecution history, and a legal state of the patent right. The processing portion 140 may automatically obtain the patent information from the memory portion 130 by receiving an identification number such as an application number from a user.

The input work by the user corresponding to Step S101 is performed by the information terminal 30. The patent information is transmitted to the second information processing device 20 through the reception portion 110 and stored in the memory portion 130.

### <Step S102>

In Step S102, the second information processing device 20 creates a first instruction sentence from the patent information in the processing portion 140.

The instruction sentence is an input sentence for making a language model perform a desired operation, and the language model generates an answer sentence on the basis of the instruction sentence. The first instruction sentence is a character string for making the language model generate a summary of the patent information. The first instruction sentence is a character string including, for example, a sentence “please summarize the following patent information” and the patent information.

### <Step S103>

In Step S103, the second information processing device 20 transmits the first instruction sentence to the first information processing device 10 through the output portion 120. The first information processing device 10 inputs the first instruction sentence to the language model and generates a first answer sentence including the summary of the patent information. The second information processing device 20 obtains the first answer sentence through the reception portion 110.

### <Step S104>

In Step S104, the second information processing device 20 creates a second instruction sentence from the summary of the patent information in the processing portion 140.

The second instruction sentence is a character string for making the language model generate a question determining whether the user wants to maintain or abandon the patent. For example, the character string includes the summary of the patent information and a sentence “the inventor is struggling to decide whether to maintain or abandon the obtained patent; please create a question that will help understand the inventor's thoughts on the invention”.

### <Step S105>

In Step S105, the second information processing device 20 transmits the second instruction sentence to the first information processing device 10 through the output portion 120. The first information processing device 10 inputs the second instruction sentence to the language model and generates a second answer sentence including the question relating to the patent. The second information processing device 20 obtains the second answer sentence through the reception portion 110.

An example of the question relating to the patent is the background of the invention, which is to compensate for lack of the patent information received in Step S101.

### <Step S106>

In Step S106, the second information processing device 20 transmits the question relating to the patent to the information terminal 30 through the output portion 120.

### <Step S107>

In Step S107, the second information processing device 20 obtains a first reply, which includes a user's reply to the question relating to the patent, from the information terminal 30 through the reception portion 110.

### <Step S108>

In Step S108, the second information processing device 20 creates a third instruction sentence from the question relating to the patent, the first reply, and the summary of the patent information in the processing portion 140.

The third instruction sentence is a character string for making the language model output a maintenance or abandonment determination result of the patent. For example, the character string includes the question relating to the patent, the first reply, the summary of the patent information, and a sentence “please determine whether the user wants to maintain or abandon the patent from the following patent information and the user's answer”.

### <Step S109>

In Step S109, the second information processing device 20 transmits the third instruction sentence to the first information processing device 10 through the output portion 120. The first information processing device 10 inputs the third instruction sentence to the language model and generates a third answer sentence including the maintenance or abandonment determination result of the patent. The second information processing device obtains the third answer sentence through the reception portion 110.

The maintenance or abandonment determination result of the patent is, for example, a character string including any of abandonment, maintenance, and inability to determine.

### <Step S110>

In Step S110, the process returns to Step S104 when the maintenance or abandonment determination result of the patent obtained in Step S109 is inability to determine, and proceeds to Step S111 when the result is maintenance or abandonment.

Steps from S104 to S109 are repeated to ask the user the question relating to the patent repeatedly, so that useful information relating the patent can be extracted.

In the case where Steps from S104 to S109 are repeated, the third instruction sentence in Step S108 preferably includes a plurality of questions to the patent and replies that are obtained by repeating Steps from S104 to S107.

### <Step S111>

In Step S111, the second information processing device 20 searches the memory portion 130 for similar patents in the processing portion 140, thereby obtaining similar patents that have been determined to be maintained or abandoned and reasons for determining maintenance or abandonment of the similar patents.

As the similar patents, patents having similarities in patent classification, patent family, and remaining term of patent rights are searched for. The number of patens obtained by search is preferably increased in accordance with the number of tokens that can be input to the language model.

### <Step S112>

In Step S112, the second information processing device 20 creates, in the processing portion 140, the fourth instruction sentence from the similar patents that have been determined to be maintained or abandoned and the reasons for determining maintenance or abandonment of the similar patents.

The fourth instruction sentence is a character string for making the language model output the reason for maintenance or abandonment of the patent. For example, the character string includes the summary of the patent information, the maintenance or abandonment determination result of the patent, the similar patents that have been determined to be maintained or abandoned, the reasons for determining maintenance or abandonment of the similar patents, and a sentence “please create a reason for maintenance or abandonment of the subject patent with reference to the following samples of similar patents that have been determined to be maintained or abandoned and reasons for determining maintenance or abandonment of the similar patents”.

The fourth instruction sentence preferably includes the second instruction sentence, the second answer sentence, and the first reply. When the fourth instruction sentence includes the second instruction sentence, the second answer sentence, and the first reply, the language model is capable of generating a reason for maintenance or abandonment of the patent that could convince the user more deeply.

### <Step S113>

In Step S113, the second information processing device 20 transmits the fourth instruction sentence to the first information processing device 10 through the output portion 120. The first information processing device 10 inputs the fourth instruction sentence to the language model and generates a fourth answer sentence including a reason for maintenance or abandonment of the patent. The second information processing device obtains the fourth answer sentence through the reception portion 110.

### <Step S114>

In Step S114, the second information processing device 20 transmits the reason for maintenance or abandonment of the patent to the information terminal 30 through the output portion 120.

### <Step S115>

In Step S115, the second information processing device 20 stores the patent determined to be maintained or abandoned and the reason for maintenance or abandonment of the patent in the memory portion 130.

The use of such an information processing system enables useful information relating to the patent to be extracted from the user and the maintenance or abandonment determination result of the patent and its reason to be proposed in accordance with the user's intention.

### <Modification Example of Processing of Information Processing System>

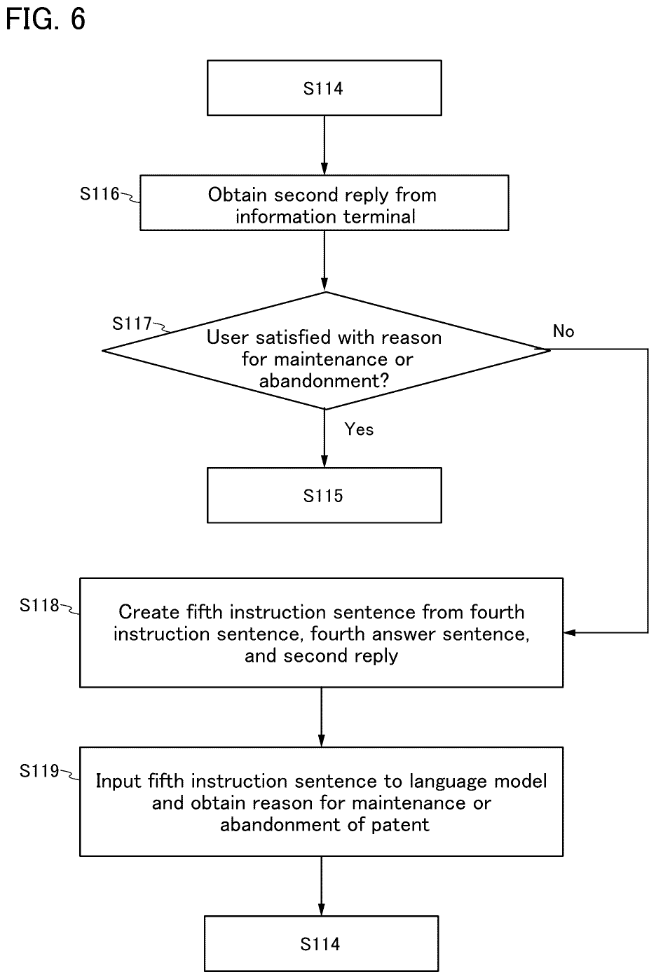

FIG. 6 is a modification example of the processing flow of the information processing system. In FIG. 6, Steps S116 to S119 are added after Step S114.

### <Step S116>

In Step S116, the second information processing device 20 obtains a second reply, which includes whether or not a correction of the reason for maintenance or abandonment of the patent is necessary, from the information terminal 30 through the reception portion 110.

In Step S116, the second reply is a character string showing the user's judgement about the reason for maintenance or abandonment of the patent output from the information processing system, and its reason.

In Step S116, the user's judgement shows whether the user is satisfied or not with the reason for maintenance or abandonment of the patent output from the information processing system.

### <Step S117>

In Step S117, the process proceeds to Step S115 when the user's judgement indicates the user's satisfaction in Step S116, and proceeds to Step S118 when the user's judgement does not indicate the user's satisfaction.

### <Step S118>

In Step S118, the second information processing device 20 creates the fifth instruction sentence from the fourth instruction sentence, the fourth answer sentence, and the second reply in the processing portion 140.

The fifth instruction sentence is a character string for making the language model output a reason for maintenance or abandonment of the patent different from the reason output in Step S113. For example, the character string includes the fourth instruction sentence, the fourth answer sentence, the second reply, and a sentence “as shown below, the user has a complaint against the following instruction sentence for outputting a reason for maintenance or abandonment of the patent, and the answer sentence to the instruction sentence; please output another reason for maintenance or abandonment of the patent”.

### <Step S119>

In Step S119, the second information processing device 20 transmits the fifth instruction sentence to the first information processing device 10 through the output portion 120. The first information processing device 10 inputs the fifth instruction sentence to the language model and generates a fifth answer sentence including a corrected reason for maintenance or abandonment of the patent. The second information processing device obtains the fifth answer sentence through the reception portion 110.

After Step S119 is ended, the process proceeds to Step S114. After that, Steps from S116 to S119 are repeated until the user is satisfied with the reason for maintenance or abandonment of the patent output from the information processing system in Step S117. Accordingly, the reason for maintenance or abandonment of the patent can be carefully considered until the user is satisfied.

This application is based on Japanese Patent Application Serial No. 2024-163471 filed with Japan Patent Office on Sep. 20, 2024, the entire contents of which are hereby incorporated by reference.

What is claimed is:

1. An information processing system comprising:
a first information processing device; and
a second information processing device,
wherein the first information processing device is configured to receive a first instruction sentence, a second instruction sentence, a third instruction sentence, and a fourth instruction sentence, perform processing using a language model, and output a first answer sentence, a second answer sentence, a third answer sentence, and a fourth answer sentence, and
wherein the second information processing device is configured to:
receive patent information of a patent to be determined to be maintained or abandoned;
create the first instruction sentence from the patent information;
transmit the first instruction sentence to the first information processing device and receive the first answer sentence comprising a summary of the patent information;
create the second instruction sentence from the summary of the patent information;
transmit the second instruction sentence to the first information processing device and receive the second answer sentence comprising a question relating to the patent;
output the question relating to the patent;
receive a first reply comprising an answer to the question relating to the patent;
create the third instruction sentence from the question relating to the patent, the first reply, and the summary of the patent information;
transmit the third instruction sentence to the first information processing device and receive the third answer sentence comprising a maintenance or abandonment determination result of the patent;
obtain similar patents that have been determined to be maintained or abandoned and reasons for determining maintenance or abandonment of the similar patents;
create the fourth instruction sentence from the summary of the patent information, the maintenance or abandonment determination result of the patent, the similar patents that have been determined to be maintained or abandoned, and the reasons for determining maintenance or abandonment of the similar patents;
transmit the fourth instruction sentence to the first information processing device and receive the fourth answer sentence comprising a reason for maintenance or abandonment of the patent;
output the reason for maintenance or abandonment of the patent; and
store the reason for maintenance or abandonment of the patent.

2. The information processing system according to claim 1,
wherein the first information processing device is configured to receive a fifth instruction sentence, perform processing using the language model, and output a fifth answer sentence, and
wherein the second information processing device is configured to:
receive a second reply comprising whether or not a correction of the reason for maintenance or abandonment of the patent is necessary;
create the fifth instruction sentence from the fourth instruction sentence, the fourth answer sentence, and the second reply; and
transmit the fifth instruction sentence to the first information processing device and receive the fifth answer sentence comprising a corrected reason for maintenance or abandonment of the patent.

3. An information processing method comprising the steps of:
obtaining patent information of a patent to be maintained or abandoned;
creating a first instruction sentence from the patent information;
inputting the first instruction sentence to a language model to obtain a first answer sentence comprising a summary of the patent information;
creating a second instruction sentence from the summary of the patent information;
inputting the second instruction sentence to the language model to obtain a second answer sentence comprising a question relating to the patent;
outputting the question relating to the patent;
obtaining a first reply comprising an answer to the question relating to the patent;
creating a third instruction sentence from the question relating to the patent, the first reply, and the summary of the patent information;
inputting the third instruction sentence to the language model to obtain a third answer sentence comprising a maintenance or abandonment determination result of the patent;
returning to the step of creating the second instruction sentence when maintenance or abandonment of the patent cannot be determined;
obtaining similar patents that have been determined to be maintained or abandoned and reasons for determining maintenance or abandonment of the similar patents when the maintenance or abandonment of the patent can be determined;
creating a fourth instruction sentence from the similar patents that have been determined to be maintained or abandoned, the reasons for determining maintenance or abandonment of the similar patents, and the summary of the patent information;
inputting the fourth instruction sentence to the language model to obtain a fourth answer sentence comprising a reason for maintenance or abandonment of the patent;
outputting the reason for maintenance or abandonment of the patent; and
storing the reason for maintenance or abandonment of the patent.

4. The information processing method according to claim 3, further comprising, after the step of outputting the reason for maintenance or abandonment of the patent, the steps of:
obtaining a second reply comprising whether or not a correction of the reason for maintenance or abandonment of the patent is necessary;
proceeding to the step of storing the reason for maintenance or abandonment of the patent when the correction of the reason for maintenance or abandonment of the patent is not necessary;
creating a fifth instruction sentence from the fourth instruction sentence, the fourth answer sentence, and the second reply when the correction is necessary;
inputting the fifth instruction sentence to the language model and obtaining a corrected reason for maintenance or abandonment of the patent; and
outputting the corrected reason for maintenance or abandonment of the patent.
